(19) United States
(12) Patent Application Publication
(10) Pub. No.: US 2014/0174104 A1
(43) Pub. Date: Jun. 26, 2014

(54) CRYOGENIC STORAGE TANK SYSTEM AND AUTO FLOW PATH SELECTOR VALVE THEREFOR

(71) Applicant: Seung Chae JEON, Busan (KR)

(72) Inventor: Seung Chae JEON, Busan (KR)

(21) Appl. No.: 13/760,476

(22) Filed: Feb. 6, 2013

(30) Foreign Application Priority Data
Dec. 26, 2012 (KR) 10-2012-0152960

(51) Int. Cl. F17C 9/02; F17C 13/04; F17C 9/00

(52) U.S. Cl. CPC F17C 9/02; F17C 9/00; F17C 13/04
USPC 62/48.1; 62/50.7

(57) ABSTRACT

A cryogenic storage tank system and an automatic flow path selector valve for the same, in which maintenance is more convenient, the length of pipes is minimized, and the pressure of liquefied gas in a gaseous phase inside a cryogenic storage tank is automatically adjusted.

### BACKGROUND OF THE INVENTION

1. Field of the Invention

The present invention relates to a technology regarding cryogenic storage tank systems which can store therein gas having a very low boiling point, such as nitrogen gas or natural gas, and more particularly, to a technology with which the pressure of liquefied gas in a gaseous phase inside cryogenic storage tank systems can be automatically adjusted.

2. Description of the Related Art

A gas that has an extremely low boiling point is maintained in a liquefied state when it is being transported or stored, and a cryogenic storage tank is used for this purpose. In general, a cryogenic storage tank is surrounded with an insulator which suppresses the transfer of heat. However, part of the liquefied gas that is stored in the cryogenic storage tank naturally evaporates because it is impossible to perfectly prevent the transfer of heat. Consequently, a certain portion of the liquefied gas exists in a gaseous phase, which is called a boil-off gas (hereinafter, referred to as ‘BOG’).

The pressure of BOG that occurs in the upper part of the inside of the cryogenic storage tank is in inverse proportion to the amount of liquefied gas that can be stored in the cryogenic storage tank. Therefore, the pressure of BOG must be properly controlled so as to stay at or below a regulated pressure.

For this, a portion of the liquefied gas that is in the gaseous phase is discharged when its pressure has arrived at a specific pressure, the discharged gas is liquefied again, and then the re-liquefied gas is returned to the cryogenic storage tank. Alternatively, the liquefied gas in the gaseous phase is used as fuel.

As a related art, there is a technology related to “APPARATUS AND METHOD FOR RE-LIQUEFYING LNG BOG,” disclosed in Korean Patent No. 10-0806569. This document discloses an apparatus for re-liquefying BOG gas that has been produced in a storage tank of an LNG carrier.

Among the attached drawings, FIG. 1 shows an apparatus for processing BOG that has been produced from liquefied gas stored in a cryogenic storage tank as a related art.

A cryogenic storage tank 10 is vertically elongated and is erected in the vertical direction. Liquefied gas in the liquid phase is stored inside the cryogenic storage tank 10, at a certain level or less. An example of the liquefied gas that is stored in the cryogenic storage tank may include N₂ gas.

The liquefied nitrogen exists as a liquid at −196° C. under atmospheric pressure.

A first discharge pipe 20 through which the liquefied gas stored in the cryogenic storage tank 10 can be discharged as required is disposed and used. A vaporizer 40 is connected to the first discharge pipe 20.

A second discharge pipe 30 through which a portion of the liquefied gas that is in the gaseous phase is discharged is disposed.

The second discharge pipe 30 is provided with an economizer 31 with which the liquefied gas in the gaseous phase can be automatically discharged when the pressure inside the cryogenic storage tank 10 arrives at a regulated value or above.

The economizer 31 is opened when the pressure of one end of the economizer 31 that is adjacent to the cryogenic storage tank 10 is greater by at least a predetermined value than the other end of the economizer 31 that is adjacent to the first discharge pipe 20 and is closed otherwise so that the economizer 31 can be opened and closed depending on changes in the pressure inside the cryogenic storage tank 10.

When the economizer 31 is opened, the liquefied gas in the gaseous phase flows toward the vaporizer 40 through the first discharge pipe 20 and the second discharge pipe 30.

In addition, in order for the economizer 31 to operate depending on the difference in pressure between the end adjacent to the cryogenic storage tank 10 and the end adjacent to the first discharge pipe 20, the following design is required. It must be designed such that the first discharge pipe 20 passes through a point that is higher than the level of the liquefied gas in the liquid phase so that a portion where the pressure is lower than the pressure at a point corresponding to the level of the liquefied gas in the liquid phase exits inside the first discharge pipe 20, and such that the economizer 31 operates depending on the difference in pressure between that portion and an end adjacent to the cryogenic storage tank 10.

According to this design, the economizer 31 must be typically disposed at the upper end of the cryogenic storage tank 10. However, this causes the maintenance of the economizer 31 to be difficult, which is problematic.

In order to overcome the foregoing problem, a related art as shown in FIG. 2 is used.

Like FIG. 1, the configuration of the related art shown in FIG. 2 includes a cryogenic storage tank 10, a first discharge pipe 20, a second discharge pipe 30, an economizer 31 and a vaporizer 40.

In FIG. 2, the configuration and arrangement of the cryogenic storage tank 10, the first discharge pipe 20 and the vaporizer 40 are the same as those shown in FIG. 1.

However, the economizer 31 shown in FIG. 2 is disposed adjacent to the ground in order to reduce the problem of maintenance. Although the economizer 31 shown in FIG. 1 is disposed above the upper end of the cryogenic storage tank 10, the economizer 31 shown in FIG. 2 is disposed at a position corresponding to the height of the lower end of the cryogenic storage tank 10.

For such an arrangement structure, in FIG. 2, the second discharge pipe 30 extends from the upper end of the cryogenic storage tank 10 in the vertically downward direction, meets the economizer 31, extends in the vertically upward direction, and then is connected to the first discharge pipe 20.

The arrangement structure of FIG. 2 has a merit in that the maintenance of the economizer 31 is convenient. However, this causes the problem that the pipes are complicated and are increased in length. This consequently increases the number of other materials such as supports which fix the pipes, which is problematic.

When the height of the cryogenic storage tank 10 is supposed to be ten meters, the lengths of the pipes that extend in the vertical direction are as follows.

In FIG. 1, the first discharge pipe 20 requires 10 m for the length that extends from the lower end to the upper end of the cryogenic storage tank 10 and 10 m for the length that extends from the upper end to the lower end of the cryogenic storage tank 10, which is a total of 20 m.

In FIG. 2, the first discharge pipe 20 requires 10 m for the length that extends from the lower end to the upper end of the cryogenic storage tank 10 and 10 m for the length that extends from the upper end to the lower end of the cryogenic storage tank 10, which is a total of 20 m. In addition, the second discharge pipe 30 requires 10 m for the length that extends from the upper end to the lower end of the cryogenic storage tank 10 and 10 m for the length that extends from the lower end to the upper end of the cryogenic storage tank 10, which is a total of 20 m. In total, the sum of the length of the first discharge pipe 20 and the length of the second discharge pipe 30 becomes 40 m.

The arrangement structure of FIG. 2 requires the length of the pipes to be increased by a total of 20 m (40 m-20 m) compared to that of the arrangement structure of FIG. 1. Consequently, other materials, such as support members which support the pipes, and additional operations for installing such materials are required.

Furthermore, according to the related art of FIG. 1 and FIG. 2, the economizer 31 operates depending on the difference in pressure between one end adjacent to the cryogenic storage tank 10 and the other end adjacent to the first discharge pipe 20. When the inside of the cryogenic storage tank 10 is filled with the liquefied gas in the liquid phase, almost no differential pressure is produced. Therefore, even when the pressure of the liquefied gas in the gaseous phase increases, it is highly probable that the economizer 31 will not operate. Even if the economizer 31 operates, the liquefied gas in the gaseous phase is discharged in a small amount, so that the pressure is not properly decreased. Consequently, the liquefied gas in the gaseous phase must be discharged to the air using a safety valve, which is problematic.

### RELATED ART DOCUMENT

[Patent Document]
1. Korean Patent No. 10-0806569 (Feb. 18, 2008)

### SUMMARY OF THE INVENTION

Accordingly, the present invention has been made keeping in mind the above problems occurring in the related art, and the present invention is intended to propose a cryogenic storage tank system and an automatic flow path selector valve for the same, in which maintenance is more convenient, the length of pipes is minimized, and the pressure of liquefied gas in a gaseous phase inside a cryogenic storage tank is automatically adjusted.

In order to achieve the above object, according to one aspect of the present invention, there is provided a cryogenic storage tank system that includes a cryogenic storage tank which stores liquefied gas therein, the cryogenic storage tank being erected in a vertical direction; a first discharge pipe having has one end connected to a lower portion of the cryogenic storage tank, wherein liquefied gas in a liquid phase is discharged through the first discharge pipe; a second gaseous phase pipe having one end connected to an upper portion of the cryogenic storage tank, the second gaseous phase pipe serving as a flow passage through which liquefied gas in a gaseous phase flows; a third discharge pipe having one end connected to the other end of the second gaseous phase pipe, wherein the liquefied gas in gaseous phase is discharged through the third discharge pipe; a fourth pressure-increasing pipe having one end disposed at the other end of the second gaseous phase pipe, the fourth pressure-increasing pipe serving as a flow passage through which pressure-increasing liquefied gas flows; an auxiliary vaporizer disposed at a middle portion of the fourth pressure-increasing pipe; and an automatic flow path selector valve including a valve body and a flow path selector member. The valve body includes a first inlet connected to the other end of the first discharge pipe, a second inlet connected to the other end of the third discharge pipe, a first outlet connected to an external main vaporizer, and a second outlet connected to the other end of the fourth pressure-increasing pipe. The flow path selector member is converted into one mode depending on pressure applied to the first inlet and pressure applied to the second inlet, the one mode being selected from the group consisting of a pressure-increasing mode in which the first inlet and the first outlet communicate with each other, the first inlet and the second outlet communicate with each other, and the second inlet and the first outlet are prevented from communicating with each other, a liquid phase discharge mode in which the first inlet and the first outlet communicate with each other, the first inlet and the second outlet are prevented from communicating with each other, and the second inlet and the first outlet are prevented from communicating with each other, and a pressure-decreasing mode in which the second inlet and the first outlet communicate with each other and the first inlet is prevented from communicating with the first outlet and is prevented from communicating with the second outlet.

In the above-described cryogenic storage tank system, it is preferred that the first discharge pipe be disposed only at a lower position than an upper end of the cryogenic storage tank, that the second gaseous phase pipe be divided into a vertical extension which extends in a vertical direction, an upper portion which connects the vertical extension to the upper portion of the cryogenic storage tank, and a lower portion which connects the vertical extension to the third discharge pipe and the fourth pressure-increasing pipe, that the upper portion of the second gaseous phase pipe be disposed only at a higher position than a lower end of the cryogenic storage tank, and that the lower portion of the second gaseous phase pipe be disposed only at a lower position than the upper end of the cryogenic storage tank.

According to another aspect of the present invention, there is provided an automatic flow path selector valve for a cryogenic storage tank system that includes a valve body comprising a first inlet through which liquefied gas in a liquid phase is introduced, a first inlet chamber communicating with the first inlet, a second inlet through which liquefied gas in a gaseous phase is introduced, a first outlet chamber formed above the first inlet chamber, a first outlet communicating with the first outlet chamber, a second outlet chamber formed below the first inlet chamber, a second outlet communicating with the second outlet chamber, a second inlet chamber formed at a side of the first outlet chamber and communicating with the second inlet, and a spring chamber formed above the first outlet chamber; and a flow path selector member that is converted into one mode depending on pressure applied to the first inlet and pressure applied to the second inlet, the one mode being selected from the group consisting of a pressure-increasing mode in which the first inlet and the first outlet communicate with each other, the first inlet and the second outlet communicate with each other, and the second inlet and the first outlet are prevented from communicating with each other, a liquid phase discharge mode in which the first inlet and the first outlet communicate with each other, the first inlet and the second outlet are prevented from communicating with each other, and the second inlet and the first outlet are prevented from communicating with each other, and a pressure-decreasing mode in which the second inlet and the first outlet communicate with each other and the first inlet is prevented from communicating with the first outlet and is prevented from communicating with the second outlet.

In the above-described automatic flow path selector valve, it is preferred that the flow path selector member include a membrane disposed between the spring chamber and the first outlet chamber, the membrane closing an upper end of the first outlet chamber; a main spring disposed in the spring chamber, the main spring applying downward elastic force to the membrane; a main rod having an upper end fixed to the membrane and a lower end extending to the first inlet chamber, wherein the main rod is vertically movable in response to and in cooperation with vertical movement of the membrane; a first valve member located in the first inlet chamber and fixed to the main rod, wherein the first valve member adjusts opening/closing between the first inlet chamber and the first outlet chamber in response to vertical movement of the main rod; a second valve member disposed in the second outlet chamber so as to be vertically movable and elastically supported in an upward direction by a second spring, wherein the second valve member is subjected to downward pressure from the main rod in response to downward movement of the main rod, thereby adjusting opening/closing between the first inlet chamber and the second outlet chamber; and a third valve member disposed between the second inlet chamber and the first outlet chamber, wherein the third valve member allows the second inlet chamber and the first outlet chamber to communicate with each other when pressure applied to the second inlet chamber has increased.

According to the cryogenic storage tank system of the present invention as described above, since the automatic flow path selector valve is disposed adjacent to the ground, the maintenance is very convenient, and the length of pipes that are required can be minimized. As the length of pipes is minimized, it is possible to exclude other related materials, such as support members, as well as operations for constructing such materials. This ensures that the cryogenic storage tank system is very economical. In addition, the pressure of the liquefied gas in the gaseous phase inside the cryogenic storage tank can be automatically adjusted.

Furthermore, the automatic flow path selector valve operates depending purely on the pressure of the liquefied gas in the gaseous phase or the pressure of the liquefied gas in the liquid phase, based on the difference in the pressure between the liquefied gas in the gaseous phase and the liquefied gas in the liquid phase. Even when the storage tank is filled with the liquefied gas in the liquid phase, the automatic flow path selector valve can normally operate. It is therefore possible to perfectly overcome the problem of the related art in which the liquefied gas in the gaseous phase is discharged through the safety valve.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a conceptual view showing an apparatus for processing BOG that has evaporated from liquefied gas stored in a cryogenic storage tank according to an example of the related art;

FIG. 2 is a conceptual view showing an apparatus for processing BOG that has evaporated from liquefied gas stored in a cryogenic storage tank according to another example of the related art;

FIG. 3A is a conceptual view showing the operation of a cryogenic storage tank system according to an embodiment of the present invention which is in a pressure-increasing mode;

FIG. 3B is a conceptual view showing the operation of the cryogenic storage tank system shown in FIG. 3A which is in a liquid phase discharge mode;

FIG. 3C is a conceptual view showing the operation of the cryogenic storage tank system shown in FIG. 3A which is in a pressure-decreasing mode;

FIG. 4 is a front elevation view of the automatic flow path selector valve shown in FIG. 3A;

FIG. 5 is a side elevation view of the automatic flow path selector valve shown in FIG. 3A;

FIG. 6 and FIG. 7 are front and side cross-sectional views showing the automatic flow path selector valve which is in the pressure-increasing mode;

FIG. 8 and FIG. 9 are front and side cross-sectional views showing the automatic flow path selector valve which is in the liquid phase discharge mode; and

FIG. 10 and FIG. 11 are front and side cross-sectional views showing the automatic flow path selector valve which is in the pressure-decreasing mode.

### DETAILED DESCRIPTION OF THE INVENTION

Reference will now be made in detail to various embodiments of the present invention, examples of which are illustrated in the accompanying drawings and described below, so that a person having ordinary skill in the art to which the present invention relates can easily put the present invention into practice. The present invention may, however, be embodied in many different forms and should not be construed as limited to the embodiments set forth herein. In the following description of the present invention, detailed descriptions of known functions and components incorporated herein will be omitted when they may make the subject matter of the present invention unclear. Throughout this document, reference should be made to the drawings, in which the same reference numerals and signs are used throughout the different drawings to designate the same or similar components.

Throughout the specification, unless explicitly stated to the contrary, the word “comprise” and its variations, such as “comprises” or “comprising” will be understood to imply the inclusion of stated elements but not the exclusion of any other elements.

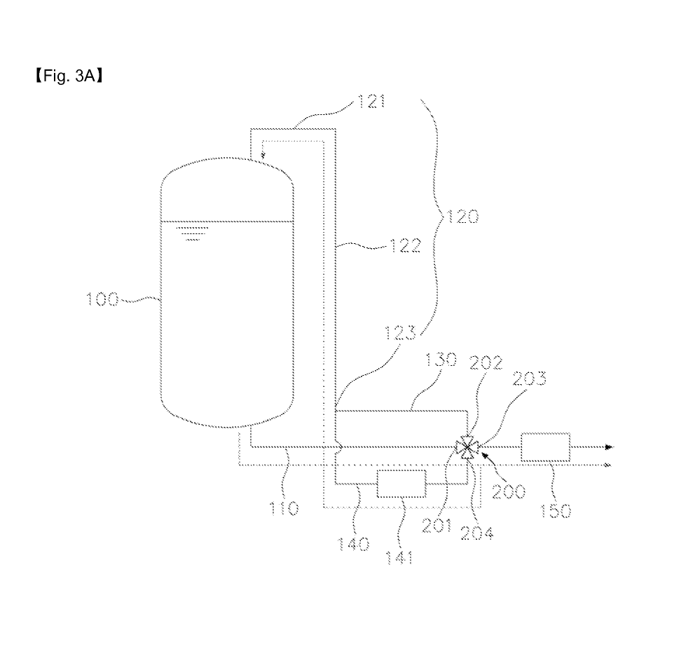

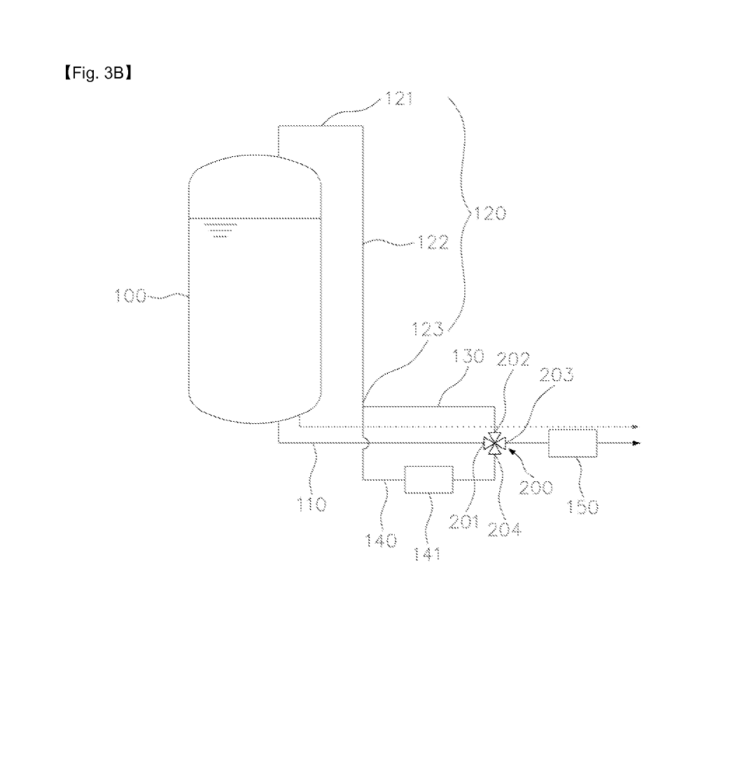

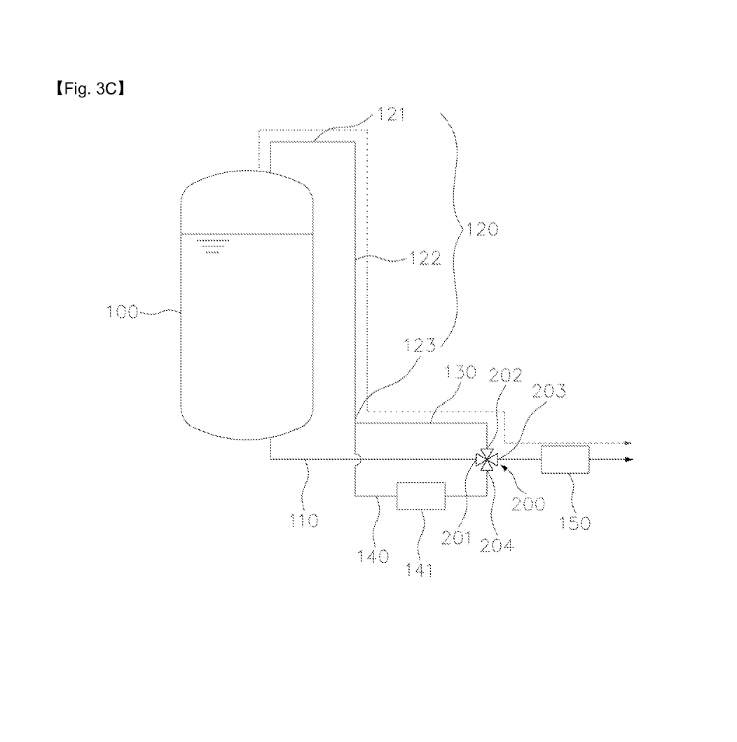

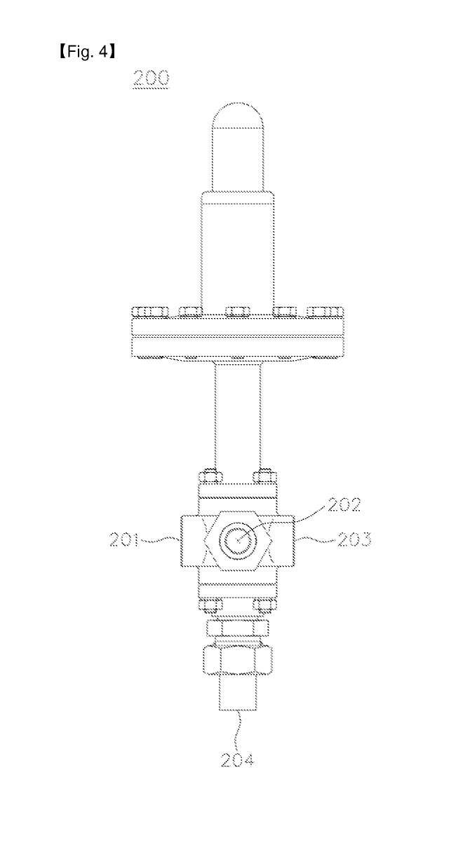

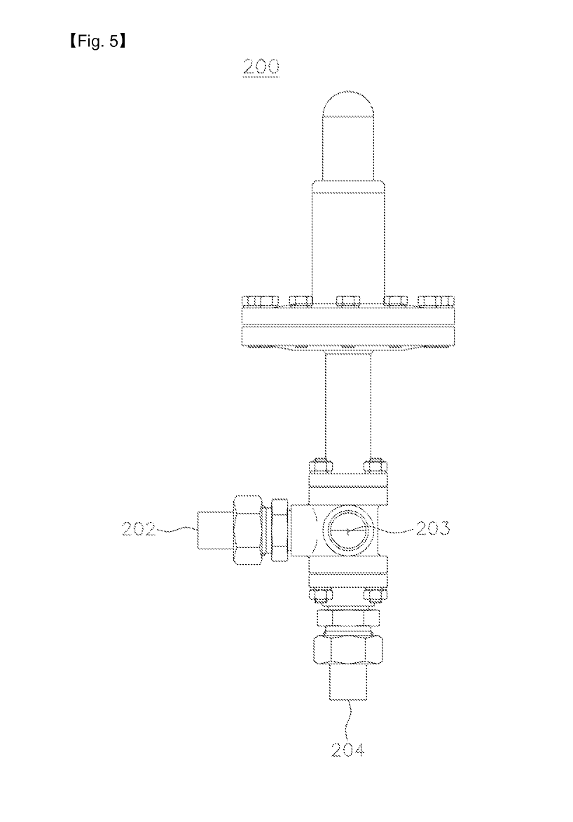

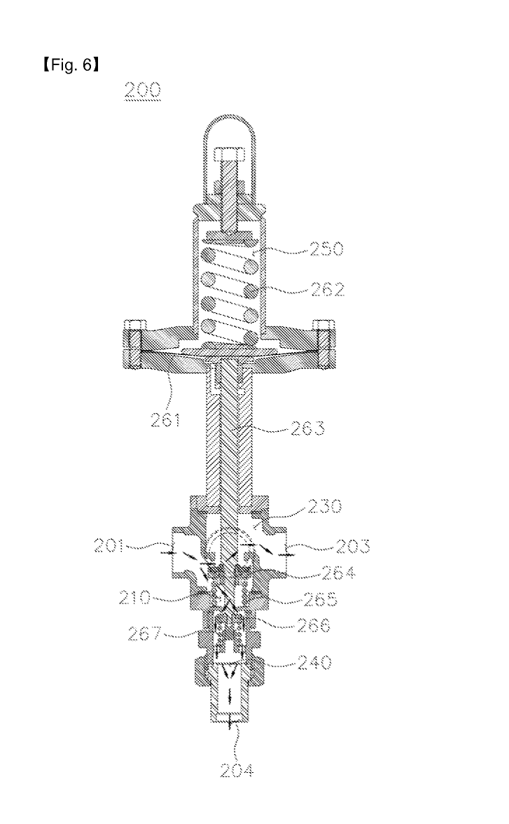

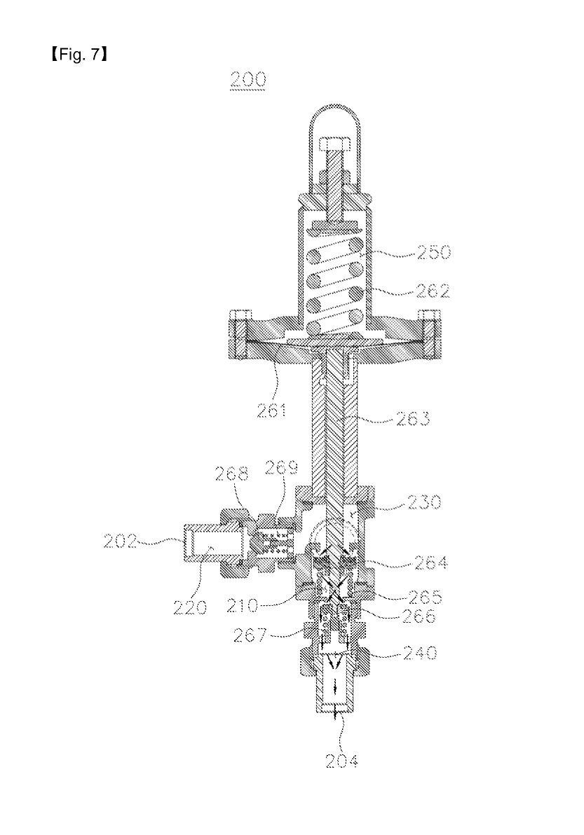

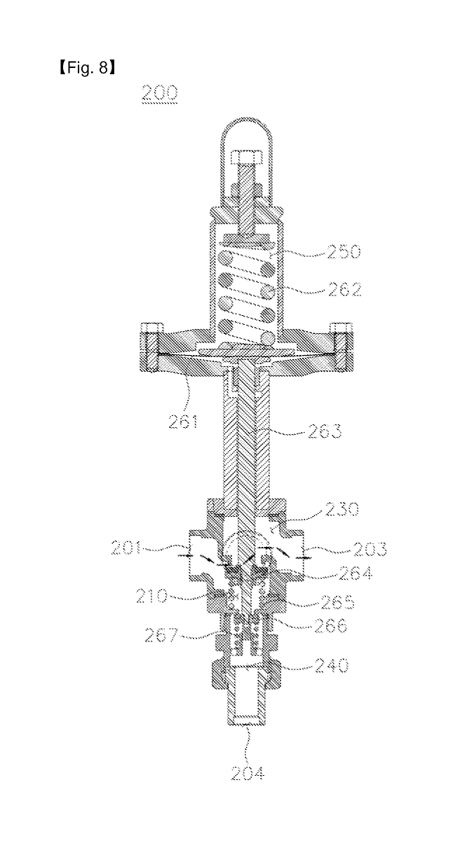

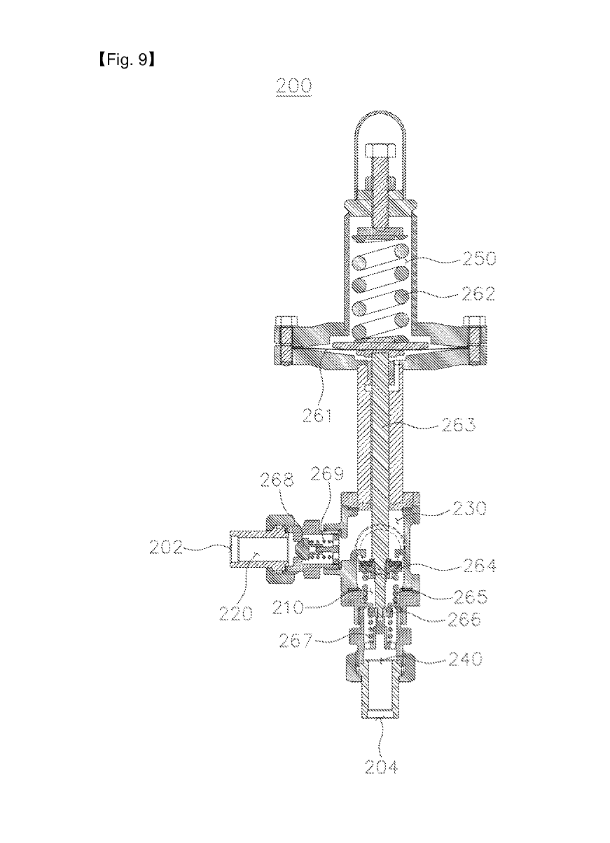

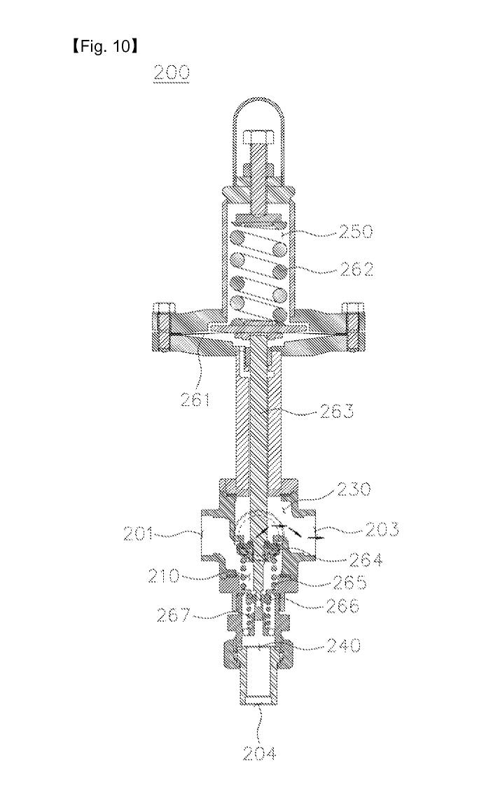

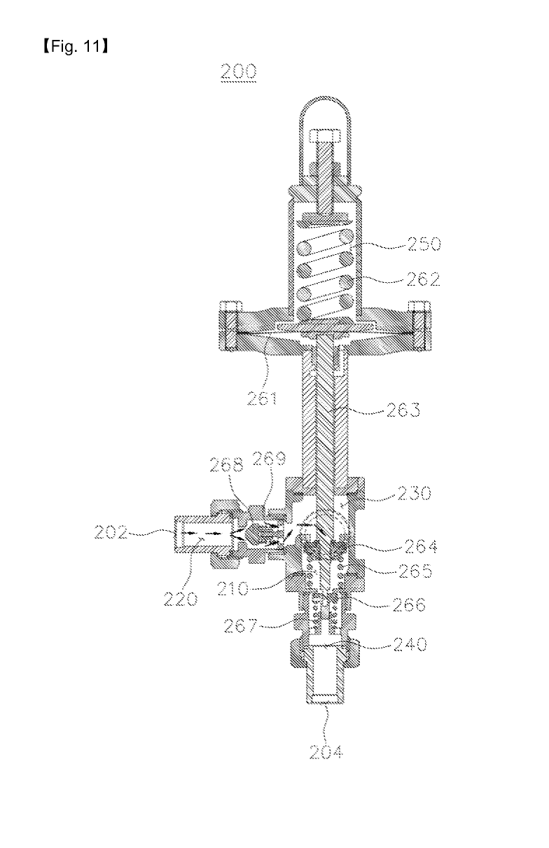

FIG. 3A is a conceptual view showing the operation of a cryogenic storage tank system according to an embodiment of the present invention which is in a pressure-increasing mode, FIG. 3B is a conceptual view showing the operation of the cryogenic storage tank system shown in FIG. 3A which is in a liquid phase discharge mode, FIG. 3C is a conceptual view showing the operation of the cryogenic storage tank system shown in FIG. 3A which is in a pressure-decreasing mode, FIG. 4 is a front elevation view of the automatic flow path selector valve shown in FIG. 3A, FIG. 5 is a side elevation view of the automatic flow path selector valve shown in FIG. 3A, FIG. 6 and FIG. 7 are front and side cross-sectional views showing the automatic flow path selector valve which is in the pressure-increasing mode, FIG. 8 and FIG. 9 are front and side cross-sectional views showing the automatic flow path selector valve which is in the liquid phase discharge mode, and FIG. 10 and FIG. 11 are front and side cross-sectional views showing the automatic flow path selector valve which is in the pressure-decreasing mode.

The cryogenic storage tank system of the present invention has advantages in that maintenance is easier and the length of pipes can be reduced compared to the traditional technology.

More specifically, the cryogenic storage tank system 100 according to an embodiment of the present invention includes a cryogenic storage tank 100, a first discharge pipe 110, a second gaseous phase pipe 120, a third discharge pipe 130, a fourth pressure-increasing pipe 140 and an automatic flow path selector valve 400.

The cryogenic storage tank 100 stores liquefied gas therein, and is surrounded by an insulator so that it can maintain the liquefied gas at a suitable temperature. Examples for the liquefied gas that can be stored in the cryogenic storage tank 100 may include liquefied nitrogen, liquefied natural gas, or the like. The cryogenic storage tank 100 has a shape that is vertically elongated and is erected in the vertical direction.

The cryogenic storage tank 100 stores the liquefied gas therein at a predetermined level. The liquefied gas stored in the cryogenic storage tank 100 naturally vaporizes, such that the liquefied gas in the gaseous phase is present in the upper part of the cryogenic storage tank 100. The liquefied gas in the gaseous phase that has evaporated inside the cryogenic storage tank 100 increases the pressure inside the cryogenic storage tank 100. The pressure inside the cryogenic storage tank 100 is required to be properly adjusted.

Specifically, the pressure inside the cryogenic storage tank 100 must be decreased when it is greater than a first reference value and must be increased when it is less than a second reference value. Here, it is required for the liquefied gas in the gaseous phase to be used without being discarded when the pressure inside the cryogenic storage tank 100 is adjusted.

Accordingly, the present invention provides a technology that reduces the length of pipes, facilitates maintenance and enables recycling of the liquefied gas in the gaseous phase using the first discharge pipe 110, the second gaseous phase pipe 120, the third discharge pipe 130, the fourth pressure-increasing pipe 140 and the automatic flow path selector valve 200.

The first discharge pipe 110 is connected to the lower portion of the cryogenic storage tank 100. One end of the first discharge pipe 110 extends along the ground after being connected to the lower portion of the cryogenic storage tank 100. The liquefied gas in the liquid phase can be discharged through the first discharge pipe 110.

Compared to the related art that was mentioned above, the length of the first discharge pipe 110 can be significantly reduced. Since the related art must use the head pressure of the liquefied gas stored in the cryogenic storage tank 100, it was required to extend the first discharge pipe 110 to a lower position adjacent to the ground after extending it above the cryogenic storage tank 100.

However, in the present invention, since the first discharge pipe 110 is connected to the lower portion of the cryogenic storage tank 100, it is not required to extend the first discharge pipe 110 downward again after extending it above the cryogenic storage tank 100. As an effect, the length of the first discharge pipe can be significantly reduced.

The second gaseous phase pipe 120 and the third discharge pipe 130 are provided in order to discharge the liquefied gas in the gaseous phase that is to be collected in the upper portion inside the cryogenic storage tank 100.

The second gaseous phase pipe 120 is disposed such that one end thereof extends to a position adjacent to the ground after being connected to the upper portion of the cryogenic storage tank 100 and the other end thereof is connected to one end of the third discharge pipe 130.

The second gaseous phase pipe 120 also acts as a flow path for the liquefied gas in the gaseous phase, and the third discharge pipe 130 is used as a path through which the liquefied gas in the gaseous phase is discharged.

The other end of the second gaseous phase pipe 120 is connected to one end of the fourth pressure-increasing pipe 140.

The fourth pressure-increasing pipe 140 acts as a flow path for the liquefied gas the pressure of which is to be increased. The fourth pressure-increasing pipe 140 is provided with a vaporizer 141, which gasifies the liquefied gas in the liquid phase into the liquefied gas in the gaseous phase.

In this fashion, the other end of the second gaseous phase pipe 120 is divided into two branches which are respectively connected to the third discharge pipe 130 and the fourth pressure-increasing pipe 140.

The other ends of the first discharge pipe 110, the third discharge pipe 130 and the fourth pressure-increasing pipe 140 are connected to the automatic flow path selector valve 200.

The automatic flow path selector valve 200 is a valve which has two inlets 201 and 202 and two outlets 203 and 204. The first discharge pipe 110 is connected to the first inlet 201, the third discharge pipe 130 is connected to the second inlet 202, and the fourth pressure-increasing pipe 140 is connected to the second outlet 204.

In addition, a main vaporizer 150 can be connected to the first outlet 203 of the automatic flow path selector valve 200. The main vaporizer 150 is like a type of heat exchanger which increases the temperature of the liquefied gas in the liquid or gaseous phase from a low temperature to a suitable temperature.

In the automatic flow path selector valve 200, the first and second inlets 201 and 202 and the first and second outlets 203 and 204 are located adjacent to the valve body, and a flow path selector member is provided in the valve body. The flow path selector member operates depending on the pressure applied to the first inlet 201 and the pressure applied to the second inlet 202. In this fashion, the automatic flow path selector valve 200 selects one mode among i) a pressure-increasing mode in which the first inlet 201 and the first outlet 203 communicate with each other, the first inlet 201 and the second outlet 204 communicate with each other, and the second inlet 202 and the first outlet 203 are prevented from communicating with each other, ii) a liquid phase discharge mode in which the first inlet 201 and the first outlet 203 communicate with each other, the first inlet 201 and the second outlet 204 are prevented from communicating with each other, and the second inlet 202 and the first outlet 203 are prevented from communicating with each other, and iii) a pressure-decreasing mode in which the second inlet 202 and the first outlet 203 communicate with each other and the first inlet 201 is prevented from communicating with the first outlet 203 and is prevented from communicating with the second outlet 204.

In addition, the valve body of the automatic flow path selector valve 200 has defined therein a first inlet chamber 201 which communicates with the first inlet 201, a first outlet chamber 203 which is formed above the first inlet chamber 210 and communicates with the first outlet 203, a second outlet chamber 240 which is formed below the first inlet chamber 210 and communicates with the second outlet 204, a second inlet chamber 220 which is formed at one side of the first outlet chamber 230 and communicates with the second inlet 202, and a spring chamber 250 which is formed above the first outlet chamber 230.

The flow path selector member includes a membrane 261, a main spring 262, a main rod 263, a first valve member 264, a second valve member 266, a third valve member 268 and the like.

The membrane 261 is disposed between the spring chamber 250 and the first outlet chamber 230, and closes the upper portion of the first outlet chamber 230.

The main spring 262 is disposed in the spring chamber 250 such that downward elastic force is applied to the membrane 261.

Due to this structure, the membrane 261 moves vertically depending on changes in the pressure applied to the first outlet chamber 230 and the elastic pressure of the main spring 262.

Of course, the lower portion of the membrane 261 communicates with the first outlet chamber 230 such that the same pressure as the pressure applied to the first outlet chamber 230 can be applied thereto.

The main rod 263 is disposed in the lower portion of the membrane 261.

The upper end of the main rod 263 is fixed to the membrane 261, and the lower end of the main rod 263 extends to the first inlet chamber 210, and preferably, to the second outlet chamber 240. With this configuration, the main rod 263 can move up and down in cooperation with the membrane 261 depending on the vertical movement of the membrane 261.

The first valve member 264 is fixed to the main rod 263, and is located in the first inlet chamber 210.

The first valve member 264 adjusts opening/closing between the first inlet chamber 210 and the first outlet chamber 230 depending on the vertical movement of the main rod 263.

In addition, a first spring 265 which applies bidirectional elastic force to the first valve member 264 is disposed in the first inlet chamber 210.

A second valve member 266 is disposed in the second outlet chamber such that it can vertically move.

The second valve member 266 is elastically supported in the vertical direction by a second spring 267 which is disposed in the second outlet chamber 240. Therefore, the second valve member 266 prevents the first inlet chamber 210 and the second outlet chamber 240 from communicating with each other when no external force is applied.

In addition, the second valve member 266 is subjected to downward pressure from the rod 263 in response to the downward movement of the main rod 263, and adjusts the degree of opening/closing so that the first inlet chamber 210 and the second outlet chamber 240 communicate with each other.

A third valve member 263 is disposed between the second inlet chamber 220 and the first outlet chamber 230.

The third valve member 268 prevents the second inlet chamber 220 and the first outlet chamber 230 from communicating with each other using the third spring 269 when no external force is applied. The degree of opening/closing is adjusted such that the second inlet chamber 220 and the first outlet chamber 230 communicate with each other when pressure applied to the second inlet chamber 220 increases.

A description will be given below of the operation of the automatic flow path selector valve 200.

First, with reference to FIG. 3A, FIG. 6 and FIG. 7, a description will be given of a case in which the pressure inside the cryogenic storage tank 100 is smaller than the second reference value.

The pressure inside the cryogenic storage tank 100 is determined depending on the pressure of the liquefied gas in the gaseous phase that is in the cryogenic storage tank. Therefore, when the inside pressure is small, it is required to increase the pressure of the liquefied gas in the gaseous phase.

Since the pressure of the liquefied gas in the gaseous phase is small, the pressure of the second inlet 202 of the automatic flow path selector valve 200 that is connected to the second gaseous phase pipe 120 and the third discharge pipe 130 is small. Consequently, the third valve member 268 is not opened, thereby preventing the second inlet chamber 220 and the first outlet chamber 203 from communicating with each other.

In addition, since small pressure is applied to the first outlet chamber 230, the membrane 261 moves downward, and the main rod 263 moves downward in cooperation with the membrane 261. The second valve member 266 fixed to the main rod 263 moves downward in response to the downward movement of the lower end of the main rod 263. The first inlet chamber 210 communicates with both the first outlet chamber 230 and the second outlet chamber 240.

According to the above-described process, the automatic flow path selector valve 200 is converted into the pressure-increasing mode in which the first inlet 201 and the first outlet 203 communicate with each other, the first inlet 201 and the second outlet 204 communicate with each other, and the second inlet 202 and the first outlet 203 are prevented from communicating with each other.

Therefore, as shown in FIG. 3A, a portion of the liquefied gas in the liquid phase that has been discharged through the first discharge pipe 110 is introduced to the main vaporizer 150 via the first outlet 203, is gasified while passing through the main vaporizer 150, and is then discharged to the outside. In contrast, another portion of the liquefied gas in the liquid phase that has been discharged through the first discharge pipe 110 is introduced into an auxiliary vaporizer 141 of the fourth pressure-increasing pipe 140 via the second outlet 204, is gasified in the auxiliary vaporizer 141, and is then introduced again into the cryogenic storage tank 100 via the second gaseous phase pipe 120.

Consequently, the pressure inside the cryogenic storage tank 100 is increased.

Next, with reference to FIG. 3B, FIG. 8 and FIG. 9, a description will be given of a case in which the pressure inside the cryogenic storage tank 100 is between the second reference value and the first reference value.

When the pressure inside the cryogenic storage tank 100 is between the second reference value and the first reference value, it is sufficient that the liquefied gas in the liquid phase is discharged to the main vaporizer 150.

Since the pressure of the liquefied gas in the gaseous phase is still smaller than the first reference value, the pressure of the second inlet 202 of the automatic flow path selector valve 200 that is connected to the second gaseous phase pipe 120 and the third discharge pipe 130 is small. Consequently, the third valve member 268 is not opened, thereby preventing the second inlet chamber 220 and the first outlet chamber 230 from communicating with each other.

Since the first outlet chamber 230 is also subjected to small pressure, the membrane 261 tends to move downward.

However, since the liquefied gas in the liquid phase that is under relatively great pressure is introduced through the first inlet 201, the pressure of the first inlet chamber 210 increases. Consequently, the second valve member 266 is subjected to upward pressure from the liquefied gas in the liquid phase, so that the main rod 263 to which the second valve member 266 is fixed tends to move upward.

Consequently, the main rod 263 is positioned at a middle height due to the pressure applied to the membrane 261 and the pressure applied to the second valve member 266. At this time, the main rod 263 does not apply downward pressure to the third valve member 268.

Therefore, the third valve member 268 moves upward in response to the elastic force of the third spring 269, so that the first inlet chamber 210 and the second outlet chamber 240 are prevented from communicating with each other.

At the same time, the second valve member 266 stays in the state in which it allows communication between the first inlet chamber 210 and the first outlet chamber 230.

According to the above-described process, the automatic flow path selector valve 200 is converted into the liquid phase discharge mode in which the first inlet 201 and the first outlet 203 communicate with each other, the first inlet 201 and the second outlet 204 are prevented from communicating with each other, and the second inlet 202 and the first outlet 203 are prevented from communicating with each other.

Therefore, as shown in FIG. 3B, all of the liquefied gas in the liquid phase that has been discharged through the first discharge pipe 110 is introduced to the main vaporizer 150 via the first outlet 203, is gasified while passing through the main vaporizer 150, and is then discharged to the outside. This is a normal operating process.

Next, with reference to FIG. 3C, FIG. 10 and FIG. 11, a description will be given of a case in which the pressure inside the cryogenic storage tank 100 is greater than the first reference value.

When the pressure inside the cryogenic storage tank 100 is smaller than the first reference value, the liquefied gas in the gaseous phase can be discharged to the main vaporizer, thereby decreasing the pressure inside the cryogenic storage tank 100.

When the pressure of the liquefied gas in the gaseous phase is greater than the first reference value, the pressure of the second inlet 202 of the automatic flow path selector valve 200 that is connected to the second gaseous phase pipe 120 and the third discharge pipe 130 is great. Consequently, the third valve member 268 is opened, thereby allowing the second inlet chamber 220 and the first outlet chamber 230 to communicate with each other.

In addition, since great pressure is applied to the first outlet chamber 230, the membrane 261 moves upward, and the main rod 263 connected to the membrane 261 also moves upward.

As the main rod 263 moves upward, the second valve member 266 fixed to the main rod 263 moves upward, thereby preventing the first inlet chamber 210 and the first outlet chamber 240 from communicating with each other.

In addition, the third valve 268 moves upward under the elastic force of the third spring 269, thereby preventing the first inlet chamber 210 and the first outlet chamber 240 from communicating with each other.

According to the above-described process, the automatic flow path selector valve 200 is converted into the pressure-decreasing mode in which the second inlet 202 and the first outlet 203 communicate with each other and the first inlet 201 is prevented from communicating with the first outlet 203 and is prevented from communicating with the second outlet 204.

Consequently, as shown in FIG. 3C, after the liquefied gas in the gaseous phase inside the cryogenic storage tank 100 is introduced into the second inlet 202 through the second gaseous phase pipe 120 and the third discharge pipe 130, it is introduced into the main vaporizer 150 through the first outlet 203 and is increased in temperature while passing through the main vaporizer 150. Afterwards, the liquefied gas that was increased in temperature is discharged to the outside. According to the above-described process, the pressure inside the cryogenic storage tank 100 is normalized, and the liquefied gas in the gaseous phase can be used as fuel or the like.

According to this embodiment as described above, when the pressure of the cryogenic storage tank 100 exceeds the first reference value, the first inlet 201 of the automatic flow path selector valve 200 connected to the first discharge pipe 110 through which the liquefied gas in the liquid phase is discharged is closed, so that the liquefied gas in the liquid phase is no longer discharged and the liquefied gas in the gaseous phase is discharged only through the second gaseous phase pipe 120 and the third discharge pipe 130. It is therefore possible to more rapidly discharge the liquefied gas in the gaseous phase that has been produced inside the cryogenic storage tank 100, which is advantageous.

According to this embodiment as described above, it is possible to minimize the length of the pipes and locate the automatic flow path selector valve adjacent to the ground, thereby advantageously providing convenience in maintenance.

The advantages of the present invention as described above can be maximized by designing the compact structure of the pipes, as shown in FIG. 3A.

Specifically, the first discharge pipe 110 is disposed at a lower position than the upper end of the cryogenic storage tank 100, and preferably, only at a lower position than the middle height of the cryogenic storage tank 100. That is, it is sufficient for the first discharge pipe 110 to extend from a height that is the same as the height of the lower end of the cryogenic storage tank 100 or adjacent to the ground.

In addition, the second gaseous phase pipe 120 can be divided into a vertical extension 122 which extends in the vertical direction, an upper portion 121 which connects the vertical extension 122 to the upper end of the cryogenic storage tank 100, and a lower portion 123 which connects the vertical extension 122, the third discharge pipe 130 and the fourth pressure-increasing pipe 140 to each other.

In addition, the upper portion 121 is disposed only at a higher position than the lower end of the cryogenic storage tank 100, and preferably, only at a higher position than the middle height of the cryogenic storage tank 100. The lower end 123 is disposed only at a lower position than the upper end of the cryogenic storage tank 100, and preferably, only at a lower position than the middle height of the cryogenic storage tank 100. In practice, the upper portion 121 may be disposed only at the height of the upper end of the cryogenic storage tank 100, and the lower portion 123 may be disposed only at the height of the lower end of the cryogenic storage tank 100.

Although the length of the pipes of the present invention may vary depending on embodiments, the length of the pipes which extend in the vertical direction will be as follows when the height of the cryogenic storage tank 100 is assumed to be ten meters.

In FIG. 3A, only 10 m, i.e. the length by which the second gaseous phase pipe 120 extends from the upper end to the lower end of the cryogenic storage tank 100, is required.

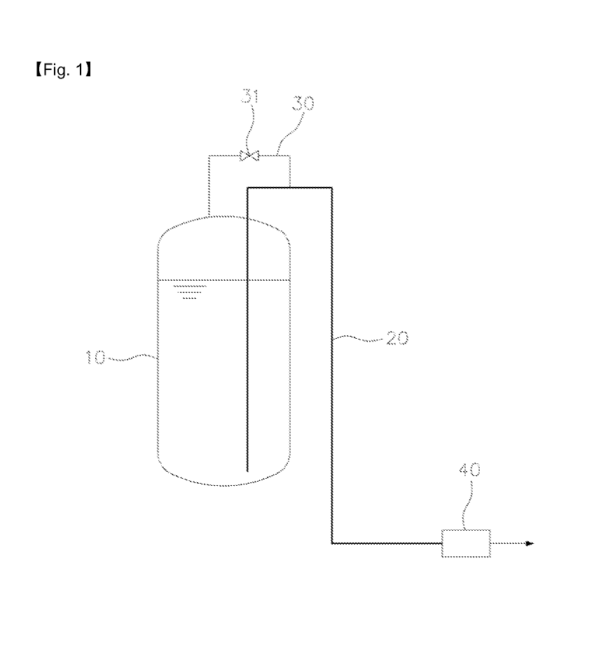

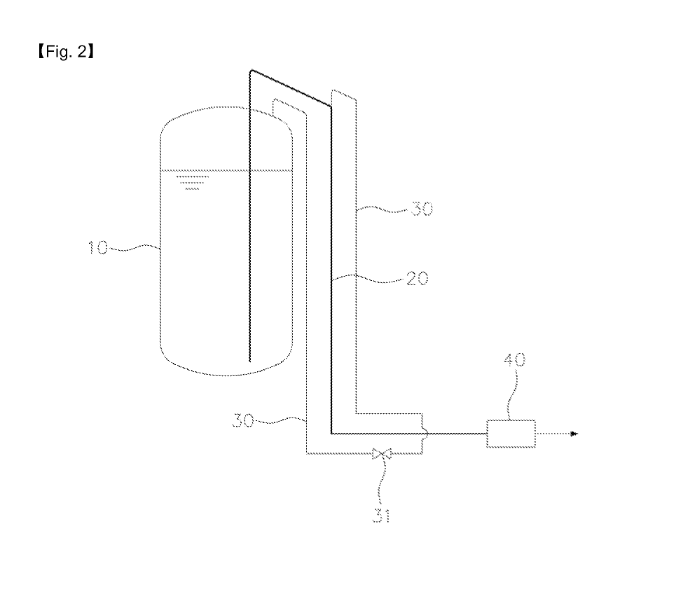

That is, the length of the pipe which extends in the vertical direction is reduced 50% or 75% from 20 m of FIG. 1 or 40 m of FIG. 2. Consequently, the number of pipe supports required is also significantly reduced, thereby making it possible to reduce costs for materials and installation.

Although the exemplary embodiments of the present invention have been described for illustrative purposes, a person having ordinary skill in the art will appreciate that changes or modifications into other detailed forms are possible without departing from the technical idea or essential features of the present invention.

What is claimed is:

1. A cryogenic storage tank system comprising:
a cryogenic storage tank which stores liquefied gas therein, the cryogenic storage tank being erected in a vertical direction;
a first discharge pipe having has one end connected to a lower portion of the cryogenic storage tank, wherein liquefied gas in a liquid phase is discharged through the first discharge pipe;
a second gaseous phase pipe having one end connected to an upper portion of the cryogenic storage tank, the second gaseous phase pipe serving as a flow passage through which liquefied gas in a gaseous phase flows;
a third discharge pipe having one end connected to the other end of the second gaseous phase pipe, wherein the liquefied gas in gaseous phase is discharged through the third discharge pipe;
a fourth pressure-increasing pipe having one end disposed at the other end of the second gaseous phase pipe, the fourth pressure-increasing pipe serving as a flow passage through which pressure-increasing liquefied gas flows;
an auxiliary vaporizer disposed at a middle portion of the fourth pressure-increasing pipe; and
an automatic flow path selector valve comprising:
a valve body comprising a first inlet connected to the other end of the first discharge pipe, a second inlet connected to the other end of the third discharge pipe, a first outlet connected to an external main vaporizer, and a second outlet connected to the other end of the fourth pressure-increasing pipe; and
a flow path selector member that is converted into one mode depending on pressure applied to the first inlet and pressure applied to the second inlet, the one mode being selected from the group consisting of a pressure-increasing mode in which the first inlet and the first outlet communicate with each other, the first inlet and the second outlet communicate with each other, and the second inlet and the first outlet are prevented from communicating with each other, a liquid phase discharge mode in which the first inlet and the first outlet communicate with each other, the first inlet and the second outlet are prevented from communicating with each other, and the second inlet and the first outlet are prevented from communicating with each other, and a pressure-decreasing mode in which the second inlet and the first outlet communicate with each other and the first inlet is prevented from communicating with the first outlet and is prevented from communicating with the second outlet.

2. The cryogenic storage tank system of claim 1, wherein:
the first discharge pipe is disposed only at a lower position than an upper end of the cryogenic storage tank;
the second gaseous phase pipe is divided into a vertical extension which extends in a vertical direction, an upper portion which connects the vertical extension to the upper portion of the cryogenic storage tank, and a lower portion which connects the vertical extension to the third discharge pipe and the fourth pressure-increasing pipe;
the upper portion of the second gaseous phase pipe is disposed only at a higher position than a lower end of the cryogenic storage tank; and
the lower portion of the second gaseous phase pipe is disposed only at a lower position than the upper end of the cryogenic storage tank.

3. An automatic flow path selector valve for a cryogenic storage tank system, comprising:
a valve body comprising a first inlet through which liquefied gas in a liquid phase is introduced, a first inlet chamber communicating with the first inlet, a second inlet through which liquefied gas in a gaseous phase is introduced, a first outlet chamber formed above the first inlet chamber, a first outlet communicating with the first outlet chamber, a second outlet chamber formed below the first inlet chamber, a second outlet communicating with the second outlet chamber, a second inlet chamber formed at a side of the first outlet chamber and communicating with the second inlet, and a spring chamber formed above the first outlet chamber; and
a flow path selector member that is converted into one mode depending on pressure applied to the first inlet and pressure applied to the second inlet, the one mode being selected from the group consisting of a pressure-increasing mode in which the first inlet and the first outlet communicate with each other, the first inlet and the second outlet communicate with each other, and the second inlet and the first outlet are prevented from communicating with each other, a liquid phase discharge mode in which the first inlet and the first outlet communicate with each other, the first inlet and the second outlet are prevented from communicating with each other, and the second inlet and the first outlet are prevented from communicating with each other, and a pressure-decreasing mode in which the second inlet and the first outlet communicate with each other and the first inlet is prevented from communicating with the first outlet and is prevented from communicating with the second outlet.

4. The automatic flow path selector valve of claim 3, wherein the flow path selector member comprises:
a membrane disposed between the spring chamber and the first outlet chamber, the membrane closing an upper end of the first outlet chamber;
a main spring disposed in the spring chamber, the main spring applying downward elastic force to the membrane;
a main rod having an upper end fixed to the membrane and a lower end extending to the first inlet chamber, wherein the main rod is vertically movable in response to and in cooperation with vertical movement of the membrane;
a first valve member located in the first inlet chamber and fixed to the main rod, wherein the first valve member adjusts opening/closing between the first inlet chamber and the first outlet chamber in response to vertical movement of the main rod;
a second valve member disposed in the second outlet chamber so as to be vertically movable and elastically supported in an upward direction by a second spring, wherein the second valve member is subjected to downward pressure from the main rod in response to downward movement of the main rod, thereby adjusting opening/closing between the first inlet chamber and the second outlet chamber; and
a third valve member disposed between the second inlet chamber and the first outlet chamber, wherein the third valve member allows the second inlet chamber and the first outlet chamber to communicate with each other when pressure applied to the second inlet chamber has increased.
